(19) United States
(12) Patent Application Publication
(10) Pub. No.: US 2009/0151967 A1
(43) Pub. Date: Jun. 18, 2009

(54) Hand-held power tool with vibration compensator

(75) Inventors: Guenter Haas, Kaufering (DE); Franz Moessnang, Landsberg (DE); Josef Fuenfer, Koenigsbrunn (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/316,235

(22) Filed: Dec. 9, 2008

(30) Foreign Application Priority Data
Dec. 13, 2007 (DE) 10 2007 055 792.4

(51) Int. Cl. B25D 17/24

(52) U.S. Cl. 173/162.1

(57) ABSTRACT

An electrical hand-held power tool includes a driving element (9; 9′) displaceable in the tool housing (8) along a drive axis (A) for driving a working tool (7, 7′), and at least one rigid electrical module located in the housing (8), and secured therein by at least one spring (4) that preloads the electrical module against the housing (8).

### BACKGROUND OF THE INVENTION

1. Field of the Invention

The present invention relates to a hand-held power tool with a reciprocating driving element, in particular, to hammer drill, combination hammer, chisel hammer, saber saw or jig saw and having a vibration compensator.

2. Description of the Prior Art

In hand-held power tools, the tool oscillations or vibrations should be prevented from acting on the power tool handle. Due to the axial mirror symmetry of conventional hand-held power tools, these vibrations primarily take place within a vibration plane in the axial direction of the vibrations and along the guide handle.

A vibration-compensator is a vibration-capable system that consists of an abstract vibrating mass, an abstract spring, and an abstract damper which, respectively, need not be formed as concrete components. In particular, an abstract damper is often realized not as actual component, but can be practically realized as constantly occurring friction and flow losses. One distinguishes between conventional passive vibration-compensators which are exclusively excited automatically (dependent on inertia), and actively controlled vibration-compensators which are purposefully independently excited by a primarily periodic, excitation function (forced oscillations).

By suitable selection of the spring constant and mass, with a passive vibration-compensator, its natural frequency is dimensioned according to the to-be-damped interference frequency, in this case, to the vibration of the outer housing of the hand-held power tool.

French Publication FR 2237734 discloses use of a passive vibration-compensator for preventing housing vibrations in a percussion hand-held power tool.

German Patent DE 815 179 discloses arrangement of two axially oscillating passive vibration-compensators laterally on both sides of the percussion mechanism, respectively.

German Publication DE 12 819 70 discloses formation of an axially oscillating passive vibration-compensator as a hollow cylinder.

According to European Publication EP 1 415 768, a compensation mass is displaced along a plurality of axes.

European Publication EP 1 736 283 discloses a hand-held power tool in form of hammer drill that applies blows along a percussion axis and includes a passive vibration-compensator the oscillation axis of which extends parallel to the percussion axis.

The power tool weight is increased by additional compensation mass, which makes the power tool heavier. In addition, the constructional space is increased, which causes space problems and increases costs of materials.

Accordingly, an object of the present invention is to realize vibration damping for an electrical hand-held power tool that would result in a reduced weight of the power tool.

### SUMMARY OF THE INVENTION

This and other objects of the present invention, which will become apparent hereinafter, are achieved by providing a hand-held power tool having a housing, driving means displaceable in the housing along a drive axis for driving a working tool, at least one rigid electrical module located in the housing and at least one spring for securing the electric module in the housing and for preloading same against the housing.

By using a rigid electrical module, which is available in conventional electrical hand-held power tools (i.e., by using modular, necessary functional part that, with regard to its functionally important arrangement, has at least one displacement degree of freedom) as an oscillating compensation mass, a separate vibration compensator that serves exclusively for damping of vibration, becomes a not so important functional part and can be eliminated. Therefore, the vibration compensator itself does not contribute to increase of the power tool weight, which is only increased by the weight of the electrical module-supporting springs, which is insignificant.

Advantageously, there are provided two springs on opposite sides of the electrical module, respectively, for securing the module to the housing and for preloading the electrical module against the housing. The springs insure displacement of the module along the oscillation axis.

Advantageously, an oscillation axis which is defined by a tensioning direction of the at least one spring forms, with the drive axis, an angle of at least 30°, preferably of 20°, which reduces, in particular, the main excitation.

Advantageously, the electrical module is formed as a motor electronics module, so that the electrical module cannot be arbitrary arranged as a mechanically replaceable electric module.

Alternatively, the electrical module is formed as an accumulator module. This, likewise insure that the electrical module cannot be arbitrary arranged as a mechanically replaceable electric module.

Advantageously, the electrical module is connected with a highly flexible conducting strip that itself is fixedly secured to the housing. This permits to form feed and discharge conductors, which are connectable with the module, practically without any difficulties.

Advantageously, the electrical module is connected with a slidable current collector, which permits to provide high current strength feed and discharge conductors for the electrical module.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a schematic side view of a first embodiment of an electrical hand-held power tool according to the present invention; and

FIG. 2 a schematic side view of a another embodiment of an electrical hand-held power tool according to the present invention.

### DETAILED DESCRIPTION OF THE PREFERRED EMBODIMENTS

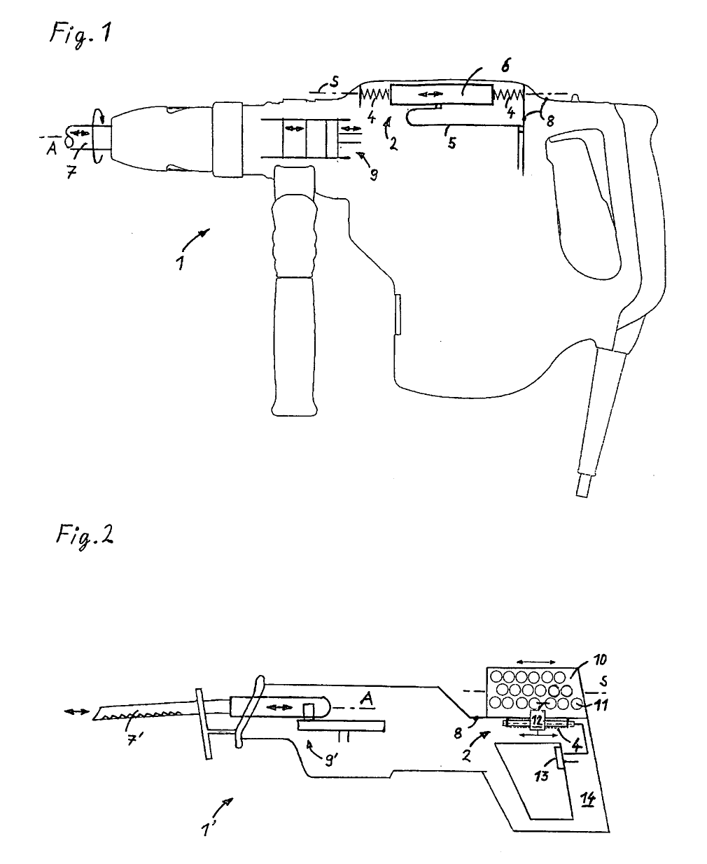

An electrical hand-held power tool 1 according to the present invention, which is formed as a hammer drill and is shown (schematically) in FIG. 1, has reciprocating driving means 9 in form of a drive piston of a pneumatic percussion mechanism that rotationally-percussively drives a working tool 7 in form of a drill about/along a drive axis A in form of a percussion axis. The power tool 1 further includes an electronic module 6 for a power tool motor and which is secured in the housing 8 of the power tool 1 with two springs 4 provided on opposite sides of the electronic module 6. The electronic module 6, together with springs 4, forms a vibration compensator 2 secured in the power tool housing 8. The tensioning direction of the springs 4 defines an oscillation axis S self-excited parallel to the driving axis A. The electric module in form of the electronic module 6, which itself is rigid, is connected with a highly flexible conducting strip 5 that itself is fixedly secured to the housing 8.

As shown in FIG. 2, a (schematically shown) electrical hand-held power tool 1′ in form of a reciprocating saw includes reciprocating drive means 9′ in form of a push rod which drives a working tool 7′ in form of a saw blade along a drive axis A that defines the reciprocating axis, and an accumulator module 10 that is fixedly secured to the housing with two spring 4 which are provided on both sides of the accumulator module 10 and which preload the accumulator module 10 against the housing 8. The accumulator module 10, together with springs 4, form vibration-compensating means 2 with a longitudinal oscillation axis S defined by the preloading direction of the springs 4. The vibration-compensation means 2 self-excitingly oscillates parallel to the drive axis A. The rigid, by itself, electric module in form of the accumulator module 10 has current cells 11 which are connected with a current collector 12 that is connected with a manual switch 13. The accumulator module 10 itself slides along a surface of the housing 8 (at a conventional use) above the handle 14, with damping of the sliding friction.

Though the present invention was shown and described with references to the preferred embodiments, such are merely illustrative of the present invention and are not to be construed as a limitation thereof and various modifications of the present invention will be apparent to those skilled in the art. It is therefore not intended that the present invention be limited to the disclosed embodiments or details thereof, and the present invention includes all variations and/or alternative embodiments within the spirit and scope of the present invention as defined by the appended claims.

What is claimed is:

1. An electrical hand-held power tool, comprising a housing (8); driving means (9; 9′) displaceable in the housing (8) along a drive axis (A) for driving a working tool (7, 7′); at least one rigid electrical module located in the housing (8); and at least one spring (4) for securing the electric module in the housing (8) and for preloading same against the housing (8).

2. An electrical hand-held power tool according to claim 1, wherein an oscillation axis (S) which is defined by a tensioning direction of the at least one spring (4), forms, with the drive axis (A), an angle of at least 30°.

3. An electrical hand-held power tool according to claim 1, comprising two springs (4) provided on opposite sides of the electrical module for securing the same to the housing (8) and for preloading the electrical module against the housing (8).

4. An electrical hand-held power tool according to claim 1, wherein the electrical module is formed as a motor electronics module (6).

5. An electrical hand-held power tool according to claim 1, wherein the electrical module is formed as an accumulator module (6).

6. An electrical hand-held power tool according to claim 1, wherein the electrical module is connected with a highly flexible conducting strip (5).

7. An electrical hand-held power tool according to claim 1, wherein the electrical module is connected with a slidable current collector (12).
